(19) United States
(12) Patent Application Publication
(10) Pub. No.: US 2009/0204444 A1
(43) Pub. Date: Aug. 13, 2009

(54) METHOD AND SYSTEM FOR MITIGATING RISK IN ISSUING WIND ONLY INSURANCE

(75) Inventors: Ricky G. Tucker, Woodstock, GA (US); Frank O. Moore, Clayton, NC (US); Laura Reinhard, Sparta, NJ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/365,032

(22) Filed: Feb. 3, 2009

Related U.S. Application Data
(60) Provisional application No. 61/027,350, filed on Feb. 8, 2008.
(60) Provisional application No. 61/035,537, filed on Mar. 11, 2008.

(51) Int. Cl. G06Q 40/00; E04C 2/20

(52) U.S. Cl. 705/4; 52/309.4

(57) ABSTRACT

A method for mitigating risk in issuing wind only insurance comprising: submitting a request for the wind only insurance; determining if a building complies with a predetermined set of parameters; if a compliant material was used in constructing the building, authorizing the request for wind only insurance; and issuing the wind only insurance.

### CROSS-REFERENCED APPLICATIONS

This application claims priority to U.S. Provisional Patent Application No. 61/027,350, filed on Feb. 8, 2008, and 61/035,537, filed on Mar. 11, 2008, both of which are incorporated herein in their entirety.

### BACKGROUND

1. Field

The present disclosure relates generally to a method and system for mitigating risk, such that underwriters will be able to issue insurance for wind only damage in high wind areas, such as coastal zones which are susceptible to tropical storms or hurricanes. In particular, the mitigation of risk and issuance of insurance results from the installation of a building system that complies with a predetermined set of parameters, such as the installation of a wind uplift resistant foam.

2. Discussion of the Background Art

It is well known that high wind forces from storms and hurricanes exert significant uplift forces and tend to remove side walls from a building structure. Building structures in the Caribbean or southeast coastal regions of the United States which are situated in the pathway of annual hurricanes encounter these wind uplift forces which result in structural damage to building and ultimately property loss.

The primary failure locations on buildings during hurricanes is the insulation or deck of building structures are particularly vulnerable to damage caused by wind uplift. When the insulation or deck of a building structure is removed in a storm, rain enters the building, often resulting in a total loss of the building and its contents. There are a number of causes of wind uplift damage to building structures including improper fastening techniques, wrong fasteners, wrong fastener spacing, and poor workmanship. Insulation or insulation face or membrane failure or poor workmanship also allow wind uplift and blow-offs.

Availability and affordability of property insurance for building owners in high wind areas remains a serious problem. Current insurance and construction methods and processes are not always integrated to mitigate loss and reduce premiums. The current methods and processes can be costly, with high deductibles, limited coverage, or coverage may not be available at all.

Current insurance and construction processes and methods are very arbitrary, focusing on probability of occurrence, with little attention to effectively mitigating or eliminating roof blow-off during high wind events. An example is the cost and lack of property insurance that currently exists in the states of Florida and Louisiana after the past hurricane seasons. Other examples would be states having to bail out insurance companies and offer state-funded and state-backed insurance policies. In addition, it can sometimes be impossible to get property insurance at any cost because of lack of insurance capacity in high wind areas.

The present inventors have discovered that utilization of a unique compliant material in a building structure, including, for example, a wind uplift resistant foam adhered thereto significantly reduces the risk that such building structure will be uplifted during high wind conditions, and thus mitigates the risk of issuing insurance, whereby once hard to obtain insurance to cover wind damage caused to building structures is now possible.

The present disclosure provides many advantages to the property insurance industry. It is cost effective, increases insurance availability, and increases property insurance industry capacity. It is a business process and method that combines property insurance providers, building contractors, and spray polyurethane foam technology to mitigate building damage and loss during high wind events. It also has the advantage of being used by spray polyurethane foam applicators to market and sell wind only insurance as an added service. Such high wind compliant building materials allow for insurers to diversify their product offers, where previous underwriting risk for make such product offerings untenable.

The present disclosure also provides many additional advantages, which shall become apparent as described below.

### SUMMARY

A method for mitigating risk in issuing wind only insurance comprising: submitting a request for the wind only insurance; determining if a building complies with a predetermined set of parameters; if a compliant material was used in constructing the building, authorizing the request for wind only insurance; and issuing the wind only insurance. The method further comprising: if a non-compliant material was used in constructing the building, arranging for a site visit. The method further comprising: after arranging for a site visit, undertaking an analysis of any the building; optionally, selecting a compliant material; and installing of the compliant material.

Preferably, the predetermined set of parameters comprises the installation of a wind uplift resistant foam. Moreover, the compliant material comprises a wind uplift resistant foam. The wind uplift resistant foam comprises a rigid closed cell foam comprises (a) a blowing agent, and (b) at least one compound selected from the group consisting of: a polyurethane and/or a polyisocyanurate polymer or combinations thereof.

Preferably, the blowing agent is at least one selected from the group consisting of: 1,1-dichloro-1-fluoroethane(HCFC-141b); 1,1,1,2-tetrafluoroethane(HFC-134a); 1,1,1,2-tetrafluoroethane(HFC-134); 1-chloro-1,1-difluoroethane(HCFC-142b); 1,1,1,3,3-pentafluorobutane(HFC-365mfc); 1,1,1,2,3,3,3-heptafluoropropane(HFC-227ea); difluoroethane(HCFC-142b); 1,1,1,3,3-pentafluoropropane(HFC-245fa), 1,1,1,2-tetrafluoroprop-1-ene(HFO-1234yf), 1,2,3,3,3-pentafluoroprop-1-ene(HFO-1225ye), 1-chloro-3,3,3-trifluoroprop-1-ene(HFO-1233zd), 1,1,1,3-tetrafluoroprop-1-ene(HFO-1234ze), 1,1,1,4,4,4-hexafluorobut-2-ene(HFO-133 6mzzm(e) and HFO-1336mzzm(z)), water, formic acid, carbon dioxide, esters, chlorocarbons, ethers, fluoroethers and combinations of any of the foregoing.

Preferably, the blowing agent is selected from the group consisting of: 1,1,1,3,3-pentafluoropropane and 1,1,1,3,3 -pentafluorobutane and mixtures thereof. One preferred blowing agent is 1,1,1,3,3-pentafluoropropane.

The foam comprises a compound selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

Optionally, the request is submitted via an Internet application or paper application. The method, further comprising: prior to issuing the wind only insurance, undertaking a review to determine if all insurance standards are met.

A further embodiment according to the present disclosure includes a method for issuing wind only insurance comprising: installing a building system; confirming that the building system complies with a predetermined set of parameters; and issuing the wind only insurance.

Still yet another embodiment includes an integrated wind risk mitigation system comprising: building insulation protection surfacing; and wind only insurance. The building insulation protection surfacing comprises: a wind risk mitigation product, and a building system. The wind risk mitigation product comprises a rigid closed cell foam comprises (a) a blowing agent, and (b) at least one compound selected from the group consisting of: a polyurethane, a polyisocyanurate, a phenol, a thermoplastic polymer and combinations thereof.

Another embodiment pertains to a wind risk mitigation insurance product comprising: a warranty against displacement of a building system from a wind uplift resistant material due to wind.

A computer readable storage media containing executable computer program instructions which when executed cause a processing system to perform a method for mitigating risk in issuing wind only insurance comprising: receiving a request for the wind only insurance; determining if a building complies with a predetermined set of parameters; if a compliant material was used in constructing the building, authorizing the request for wind only insurance; and issuing the wind only insurance. The storage media further comprising: if a non-compliant material was used in constructing the building, arranging for a site visit. Further comprising after arranging for a site visit, undertaking an analysis of any the building; optionally, selecting a compliant material; and installing of the compliant material.

Further objects, features and advantages of the present disclosure will be understood by reference to the following drawings and detailed description.

### BRIEF DESCRIPTION OF THE DRAWINGS

FIG. 1 is a block diagram depicting the issuance of insurance according to the present disclosure;

FIG. 2 is a block diagram of a computer system adapted for employment of the method according to the present disclosure;

FIG. 3 is a diagram of a building system according to the present disclosure; and

FIG. 4 is a block diagram showing an Internet property quotation process according to an embodiment of the present disclosure.

### DETAILED DESCRIPTION OF THE PREFERRED EMBODIMENT

The present disclosure is applicable to building owners, insurers, reinsurers, brokers, contractors, foam suppliers, architects, engineers, lessees and any other person or entity that is subject to risk as a result of building failure caused by high winds.

In one embodiment, applicable to insurers for example, the disclosure relates to a method for mitigating risk in issuing wind only insurance comprising: receiving a request for the wind only insurance; determining if a building system complies with a predetermined set of parameters; issuing the wind only insurance; optionally reinsuring any risk, i.e., spreading the risk of insuring to a consortium of reinsurer such as a plurality of insurers. Still yet another approach to issuing of such wind insurance is through a select group of licensed insurance brokers, wherein:
(1) one or more licensed insurance brokers would be appointed;
(2) the facilities or insurance program criteria would be established, including, but not limited to, (a) assign underwriting responsibilities to either an outside insurance company (e.g., AIG or ACE) or split underwriting responsibilities between outside insurance company(s) and a captive insurer (such as Alchem), and (b) establishment of minimal underwriting criteria that need to be met before insurance can be issued (such as physical site inspections);
(3) broker or insurer to issue insurance; and
(4) broker or insurer to collect insurance premium from insured, as well as to handle claims and state recordation requirements.

However, if a compliant material is already installed, the underwriter for the insurer can authorize the request for wind only insurance. If the building system does not comply with the predetermined set of parameters, then the insurer or the broker (as applicable) can arrange for a site visit. The method also includes analyzing the existing building system; optionally, selecting a material to correct the non-compliance; and installing a compliant material within the building system, i.e., installation of an uplift resistant material, such as a rigid closed cell spray foam.

The following shall be checked and verified regarding the building assembly prior to issuance of insurance. A deck or wall specification compliance, insulation specification compliance and surface membrane/coating specification compliance shall meet all industry standards. The building shall be inspected and in a warrantable condition by the manufacturer supplying the building system.

The proposed contractor should provide information concerning projects similar in nature to the one proposed including location and person to be contacted. Some manufacturers of sprayed polyurethane foam systems and/or protective coatings have approval programs and/or licensing methods that could be required.

Manufacturer Qualifications: Polyurethane foam and protective coating manufacturers shall show evidence of sufficient financial resources and manufacturing facilities to furnish materials on this project. References shall be required, sufficient project lists, warranties and code approvals shall be submitted for verification.

Inspections: The polyurethane foam and protective coating manufacturers are to provide qualified representatives to monitor and inspect the installation of their products. Manufacturers third party inspection of the installation is recommended. Manufacturers to provide published data sheets or letter of certification that their products comply with the materials specified. This is to include primers (if required), polyurethane foam and protective coatings.

Shop drawings on sheet metal, accessories, or other fabricated items.

Manufacturer's application or installation instructions.

Contractor/applicator certification from polyurethane foam supplier and/or protective coatings manufacturers and evidence of contractor/applicator qualification and experience.

A specimen copy of the applicable warranty for the project.

Approval and information guides for applicable local, or national codes and/or insurance acceptability, if required.

Safety and handling instructions for storage, handling and use of the materials to include appropriate Materials Safety Data Sheets (MSDS).

Field Quality Control Procedures to be utilized by the contractor/applicator to insure proper preparation and installation of polyurethane foam and protective coatings, detail work and follow-up inspection.

In another embodiment applicable to the building owner or lessee for example, the present disclosure relates to a method for mitigating risk comprising: submitting a request for wind only insurance; submitting an application for wind only insurance; optionally, enabling a site visit to enable a determination of whether the currently installed building system meets a predetermined set of parameters; optionally, facilitating the installation of a compliant roofing system; receipt of insurance; and, optionally, paying an insurance premium. If a building failure occurs due to wind damage, then the process would also include the filing of a claim and issuance of a claim payment.

In still another embodiment applicable to contractors, for example, the present disclosure relates to a method for mitigating risk comprising: submitting a proposal for installation of a building system; optionally, determining if an existing building system complies with a predetermined set of parameters; optionally, enabling a site visit to enable a determination of whether the building system meets a predetermined set of parameters; optionally, installing a compliant material; submitting an application for wind only insurance; receipt of insurance; and, optionally, paying an insurance premium. If a building failure occurs due to such compliant material, then the process would also include the filing of a claim and issuance of a claim payment.

In a still further embodiment, the present disclosure relates to a method of diversifying an insurance product offering to include property inspections, and loss control services beyond simple building inspection, such as inspection of gutters, relocation of shrubbery around the home, and relocation of hazardous vessels near the home, such as propane tanks and the like.

Each of the steps of receiving, advertising, distributing, soliciting, determining, authorizing, issuing, scheduling and reinsuring can each be accomplished by any means known in the art, including, but not limited to: electronic means (e.g., Internet, facsimile, or any other known electronic transfer system), mail, courier, personal deliver (i.e., in person), etc.

The predetermined set of parameters comprises the installation of a wind uplift resistant foam system. The compliant material comprises a wind uplift resistant foam.

The wind uplift resistant foam comprises a layer of a rigid closed cell foam, and wherein the building system comprises: (a) a rigid closed cell foam (e.g., a rigid closed cell spray foam); and (b) a concrete deck or wall, wherein the layer of a rigid closed cell foam is affixed to the deck or wall, preferably by spray application.

The rigid closed cell foam (also referred to as a rigid closed cell spray foam) comprises (a) a blowing agent, and (b) at least one compound selected from the group consisting of: a polyurethane and/or a polyisocyanurate polymer or combinations thereof. It is well known to those of skill in the art that foams described as polyisocyanurate foams are typically a mixture of polyisocyanurate and polyurethane polymers.

Any blowing agent and other additives known to be useful in polyurethane and/or polyisocyanurate polymers may be used in the present disclosure. ENOVATE® 245fa blowing agent is the preferred blowing agent.

The method also may include the step of, prior to issuing the wind only roof insurance, undertaking a review to determine if all conventional building insurance standards are met, i.e., use of certified gutters, proper location of shrubbery around the home, electrical systems meeting current codes, proper decking supports, and proper location of hazardous vessels near the home, such as propane tanks and the like.

Furthermore, the present disclosure relates to the automatic purchase of insurance for approved roofing systems made with compliant material.

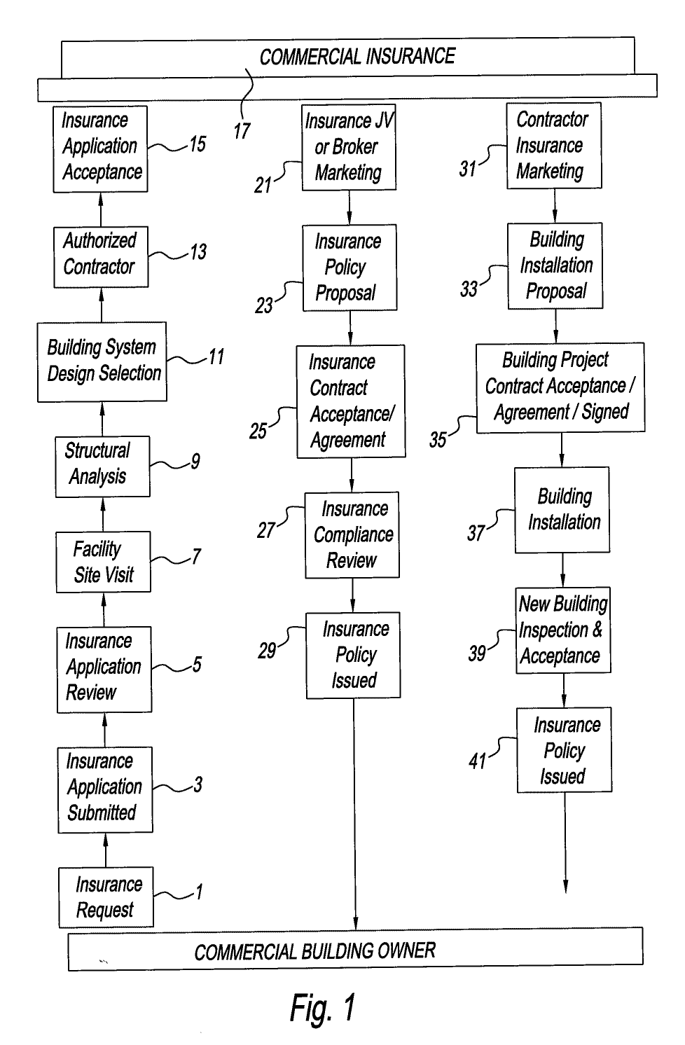

The present disclosure can best be explained by reference to FIG. 1 which depicts three instances where high wind risk may be mitigated and insurance issued to cover a building's roofing system. The first embodiment of the present disclosure involves requesting insurance 1, followed by the submission of an insurance application 3. After the application 3 has been submitted, an underwriter reviews the insurance application 5 and, optionally, conducts a facility site visit 7. If a facility site visit 7 is performed, then a structural analysis of the current roofing system is undertaken 9 by an inspector. If the inspection determines that the currently installed roofing system does not meet a predetermined set of parameters, then the building owner has the option of selecting a fully compliant roofing system 11. Once the compliant roofing system is selected, then a roofing contractor can be hired to install the compliant roofing system 13. Once the compliant roofing system has been installed, then the insurance application can be accepted 15 and insurance can be issued 17.

In another embodiment of the present disclosure, an insurance joint venture or insurance broker can market wind roof insurance 21 to building owners by sending an insurance policy proposal 23. Thereafter, an insurance contract is sent to the building owner 25 for execution. Upon receipt of the executed insurance contract, then an insurance compliant review is initiated 27 to determine if the roofing system includes a compliant material which meets or exceeds a predetermined set of parameters. If so, then an insurance policy is issued 29.

Still another embodiment described in FIG. 1, relates to a method whereby a contractor markets an insurance product together with his roofing contract 31. That is, the contractor submits a roof installation proposal to a building owner 33. If the owner accepts the proposal, then a formal contract for services and insurance is sent to the owner for execution 35. Once the contract is executed by both parties, the contractor installs the roof 37. Thereafter, the underwriter of the insurance undertakes an inspection of the roof 39 to ensure that the roof system includes a compliant material that meets or exceeds a predetermined set of parameters. If the compliant material meets or exceeds a predetermined set of parameters, then the insurer issues an insurance policy to the building owner 41.

To avoid redundancy of tasks, all of the method steps of each embodiment discussed throughout this application can be conducted by one or more individuals, groups, or computers.

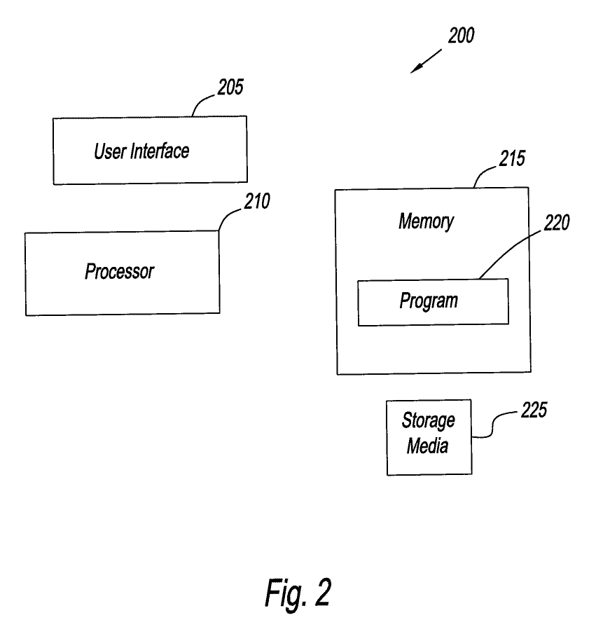

FIG. 2 is a block diagram of a computer system 200 adapted for employment of the present invention. System 200 includes a user interface 205, a processor 210, and a memory 215. System 200 may be implemented on a general purpose microcomputer. Although system 200 is represented herein as a standalone system, it is not limited to such, but instead can be implemented as a distributed computer system via a network (not shown).

Memory 215 is a memory for storing data and instructions for controlling the operation of processor 210. An implementation of memory 215 would include a random access memory (RAM), a hard drive and a read only memory (ROM). One of the components of memory 215 is a program 220.

Program 220 includes instructions for controlling processor 210 to execute the steps described above in association with the method of FIG. 1. Program 220 may be implemented as a single module or as a plurality of modules that operate in cooperation with one another. The term “module” is used herein to denote a functional operation that may be embodied either as a stand-alone component or as an integrated configuration of a plurality of sub-ordinate components.

User interface 205 includes an input device, such as a keyboard or speech recognition subsystem, for enabling a user to communicate information and command selections to processor 210. User interface 205 also includes an output device, such as a display or a printer. A cursor control such as a mouse, track-ball, or joy stick, allows the user to manipulate a cursor on the display for communicating additional information and command selections to processor 210.

While program 220 is indicated as a component of memory 215, it may be configured on a storage media 225 for subsequent loading into memory 215. Storage media 225 can be any conventional storage media such as a magnetic tape, an optical storage media, a compact disk, or a floppy disk. Alternatively, storage media 225 can be a random access memory, or other type of electronic storage, located on a remote storage system (not shown) and coupled to memory 215.

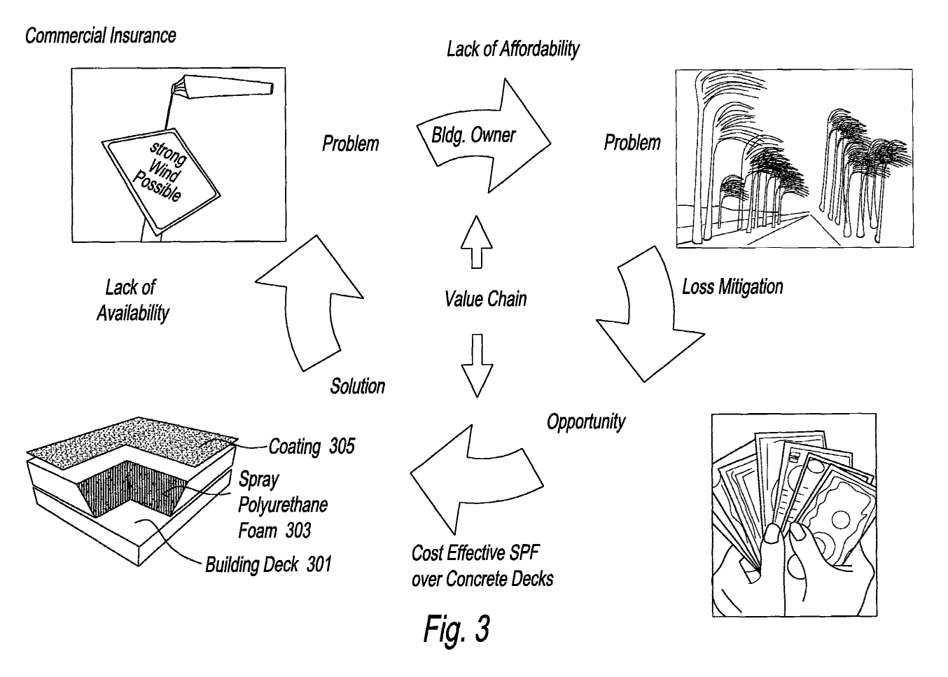

FIG. 3 is a diagram that the program, opportunity and solution provided in the issuance of commercial roofing insurance. The primary problem resides in the lack of availability of insurance policies in this area, particular in coastal areas that are susceptible to high winds, the lack of affordable insurance if any is available, and solution for just problems by providing readily available and cost effective insurance to building owners who have utilized a compliant rigid closed cell foam material in the assembly and manufacture of its building system. Such a building system comprises a deck or wall 301, spray polyurethane rigid closed cell foam 303 and a exterior protective coating 305.

### Building System.

The building system comprises: (i) deck or wall; (ii) rigid closed cell foam; and (iii) optionally, a protective surfacing disposed on the outer surface of the rigid closed cell foam to protect it from ultraviolet degradation, such as a membrane/coating system. Such a building system is applicable to new and retro-fit structures, as well as both commercial and residential building applications.

(i)—The Deck.

The decking is the substrate on which the rigid closed cell foam is applied. Typically, the decking is composed of concrete, wood, steel, composite materials, such as cemented wood fiber panels, but may also include other substrates that have the capability to attach the insulation and waterproofing materials. Concrete decks are preferred. The fabrication of these decks is well known in the art.

### (ii) The Rigid Closed Cell Foam

Closed cell spray polyurethane and polyisocyanurate foams, including their formulation and application in housing insulation applications are well known in the art. In general, polyurethane or polyisocyanurate foams are prepared by combining an (1) isocyanate, (2) a polyol, (3) a blowing agent, and optionally (4)—other additives. Each of these components and their processing to make polyurethane and polyisocyanurate foam formulations for building insulation applications is described below.

### 1—The Isocyanate Component

Any organic polyisocyanate can be employed in polyurethane or polyisocyanurate foam synthesis inclusive of aliphatic and aromatic polyisocyanates. Preferred as a class, are the aromatic polyisocyanates. Preferred aromatic polyisocyanates for rigid polyurethane or polyisocyanurate foam synthesis include the polymethylene polyphenyl isocyanates, particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates can be used alone or in any combination. Suitable commercially available isocyanates include: Lupinate® M20S from BASF, PAPI 27 from Dow, Rubinate® M from Huntsman, and Mondur® MR from Bayer.

The amount of isocyanate in polyurethane or polyisocyanurate foam formulations is generally in the range of about 40 to about 60 weight percent of the total foam formulation.

### 2—The Polyol Component

Typical polyols used in the manufacture of rigid polyurethane or isocyanurate foams include, but are not limited to, (i) aromatic amino-based polyether polyols such as those based on mixtures of 2,4- and 2,6-toluenediamine condensed with ethylene oxide and/or propylene oxide, (ii) aromatic alkylamino-based polyether polyols such as those based on ethoxylated and/or propoxylated aminoethylated nonylphenol derivatives, (iii) sucrose or sorbitol-based polyols such as those based on sucrose derivatives and/or mixtures of sucrose and glycerine derivatives condensed with ethylene oxide and/or propylene oxide, (iv) polyols derived from natural products including without limitation soy and flaxseed oil, (v) aromatic polyester polyols such as those based on complex mixtures of phthalate-type or terephthalate-type esters formed from polyols such as ethylene glycol, diethylene glycol, or propylene glycol. These polyols may used alone or in any combination.

Suitable commercially available polyols include: Voranol® 470X from Dow, Jeffol® A630 from Huntsman, Terate® 4020 from Kosa, Voranol® 370 from Dow.

The amount of polyol in the polyurethane or polyisocyanurate foam formulations is generally in the range of about 20 to about 40 weight percent of the total foam formulation.

### 3—The Blowing Agent Component

The blowing agent component can be any blowing agent known to be useful in the manufacture of polyurethane or polyisocyanurate foam. Generally these materials include: fluorocarbons (including chlorofluorocarbons (CFCs), hydrochlorofluorocarbons (HCFCs), hydrofluorocarbons (HFCs), hydrocarbons (HCs), water, CO₂, fluoroesters, fluoroethers, fluoroketones, fluoroolefins (HFOs), organic acids, ethers, esters, alcohols, and trans-1,2-dichloroethylene.

Preferred physical blowing agents are those that have some or all of the following are non-flammable, liquid, have a low molecular weight, no or low (<about 0.01 ozone depletion potential (ODP) and have a low global warming potential (GWP) (that is a GWP of less than about 1500, more preferably about 1000 or less, still more preferably less than about 500, and most preferably less than about 150):

Suitable physical blowing agents include but are not limited to:

HCFCs and HFCs of from about 1-4 carbon atoms, and HCs of from about 4-6 carbon atoms.

In certain embodiments, pentafluoropropenes are preferred, including particularly those pentafluoropropenes in which there is a hydrogen substituent on the terminal unsaturated carbon, such as CF₃CF═CFH (HFO-1225yez), particularly since applicants have discovered that such compounds have a relatively low degree of toxicity in comparison to at least the compound CF₃CH═CF₂(HFO-1225zc).

The term “HFO-1234” is used herein to refer to all tetrafluoropropenes. Among the tetrafluoropropenes are included 1,1,1,2-tetrafluoropropene(HFO-1234yf) and both cis- and trans-1,1,1,3-tetrafluoropropene(HFO-1234ze). The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

The term “HFO-1233” is used herein to refer to all trifluoro monochloropropenes. Among the trifluoromonochloropropenes are included 1,1,1,trifluoro-2,chloro-propene(HFO-1233xf) and both cis- and trans-1,1,1-trifluo-3,chlororopropene(HFO-1233zd). The term HFO-1233zd is used herein generically to refer to 1,1,1-trifluo-3, chloro-propene, independent of whether it is the cis- or trans-form. The terms “cisHFO-1233zd” and “transHFO-1233zd” are used herein to describe the cis- and trans-forms of 1,1,1-trifluo,3-chlororopropene, respectively. The term “HFO-1233zd” therefore includes within its scope cisHFO-1233zd, transHFO-1233zd, and all combinations and mixtures of these.

The term “HFO-1225” is used herein to refer to all pentafluoropropenes. Among such molecules are included 1,1,1,2,3 pentafluoropropene(HFO-1225yez), both cis- and trans-forms thereof. The term HFO-1225yez is thus used herein generically to refer to 1,1,1,2,3 pentafluoropropene, independent of whether it is the cis- or trans-form. The term “HFO-1225yez” therefore includes within its scope cisHFO-1225yez, transHFO-1225yez, and all combinations and mixtures of these.

HFOs derived from 365mfc including without limitation HFO-1354 and HFO-1345 may also be used as blowing agents in this application.

Preferred physical blowing agents include but are not limited to: 1,1-dichloro-1-fluoroethane(HCFC-141b); 1,1,1,2-tetrafluoroethane(HFC-134a); 1,1,1,2-tetrafluoroethane(HFC-134); 1-chloro-1,1-difluoroethane; 1,1,1,3,3-pentafluorobutane(HFC-142b); 1,1,1,2,3,3,3-heptafluoropropane(HFC-227ea); difluoroethane; 1,1,1,3,3-pentafluoropropane(HFC-245fa), 1,1,1,2-tetrafluoroprop-1-ene(HFO-1234yf), 1,2,3,3,3-pentafluoroprop-1-ene(HFO-1225ye), 1-chloro-3,3,3-trifluoroprop-1-ene(HFO-1233zd), 1,1,1,3-tetrafluoroprop-1-ene(HFO-1234ze), 1,1,1,4,4,4-hexafluorobut-2-ene(HFO-1336mzzm(e) and HFO-1336mzzm(z)), and combinations of any of the foregoing or combinations of any of the foregoing with other suitable blowing agents.

Suitable commercially available physical blowing agents include ENOVATE® 245fa from Honeywell and SOLKANE® 365mfc available from Solvay. When used alone these materials are present in an amount of about 3 to about 15 weight percent of the total foam formulation. When 245fa and 365mfc are used in combination they may be used in any combination however physical blowing agent compositions which are 245fa rich (i.e., >50 weight percent of the physical blowing agent composition is composed of HFC-245fa).

Chemical blowing agents include but are not limited to compounds that react with the isocyanate to liberate a gas. Preferred chemical blowing agents include water and organic acids like formic acid.

Generally speaking, the amount of blowing agent present in the foam formulation is dictated by the desired foam densities of the final polyurethane or polyisocyanurate foams products. The polyurethane and polyisocyanurate foams produced can vary in density from about 1.0 to about 6.0 pounds per cubic foot, more preferably from about 1.5 to about 4.0 pounds per cubic foot and most preferably 1.8 to 4 pound per cubic foot. The density obtained is a function of how much of the blowing agent, or blowing agent mixture, is present in the A and/or B components, or that is added at the time the foam is prepared.

The amount of physical blowing in the polyurethane or polyisocyanurate foam formulations is generally in the range of about 3 to about 15 weight percent of the total foam formulation while the amount of chemical blowing agent in such formulations is generally in the range of about 0 to about 3 weight percent of the total foam formulation.

### 4—Catalysts:

Any catalyst useful in the manufacture of polyurethane and/or polyisocyanurate foam may be used in the invention. Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

The amount of amine catalyst in the polyurethane foam formulation is generally in the range of about >0 to about 5 weight percent of the total foam formulation.

Optionally, non-amine polyurethane catalysts may be used in the polyurethane foam formulation. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

The amount of non-amine catalyst in the polyurethane foam formulations is generally in the range of about >0 to about less than 1 weight percent of the total foam formulation.

In the preparation of polyisocyanurate foams, trimerization catalysts are used for the purpose of converting excess (i.e., greater than the amount required to react with the polyol and other isocyanate-reactive components in the foam formulation). Any trimerization catalyst known to be useful in the manufacture of polyisocyanurate foam may be employed in the present invention. These catalysts include, but are not limited to, glycine salts and tertiary amine trimerization catalysts, alkali metal carboxylic acid salts, and mixtures thereof. Preferred species within these classes are potassium acetate, potassium octoate, and N-(2-hydroxy-5-nonylphenol)methyl-N-methylglycinate.

The amount of trimerization catalyst in the polyisocyanurate foam formulation is generally in the range of about >0 to about less than 5 weight percent of the total foam formulation.

### 5—Other Additives:

There are numerous additives that may be added to the foam formulation to optimize properties of the formulation. They include without limitation: surfactants, cell stabilizers, flame retardants, viscosity modifiers, crosslinking agents, solubolizers, dispersing agents, colorants, adhesion promoters, vapor pressure suppressants and stabilizers. These are all well known in the art. Generally additives are present in the foam formulation in an amount of >0 to about 15 weight percent of the total foam formulation

Closed-cell spray foam suitable for this application preferably have the following nominal properties:

| Property | ASTM Test | Unit | Value |
|---|---|---|---|
| Nominal Density: | D-1622 | lbs/ft³ | 1.5-4.0 |
| Sprayed-in-Place | | | |
| R Value at 750° F. | C-518 | R/inch | 5.0-8.0 |
| mean temperature, | | | |
| measured 6 months | | | |
| after foam | | | |
| manufacture | | | |
| Compressive | D-1621 | Psi | 20-60 |
| Strength: Parallel to | | | |
| Rise | | | |
| Tensile Strength | D-1623 | Psi | 30-100 |
| Closed Cell Content | D-2856 | % | >80 |

Useful closed-cell spray foams are disclosed in U.S. Pat. Nos. 6,414,046; 7,214,294; 6,843,934, 6,806,247, 6,790,820; 6,784,150, among others which are incorporated herein by reference.

Useful closed-cell spray foams include Comfort Foam® FE178, FE158, CF178, CF158 commercially available from BASF Polyurethanes—Foam Enterprises (a division of BASF) of Florham Park, N.J.; BaySeal™ 2.0 commercially available from BaySystems (a division of Bayer) of Spring, Tex.; Corbond® commercially available from Corbond of Bozeman, Mont.; HeatLok Soy 0240 commercially available from Demilec USA of Arlington, Tex.; Styrofoam™ 2.0 commercially available from Dow Chemical Company of Midland, Mich.; PF-173, PF-193 commercially available from Gaco Western of Seattle, Wash.; Permax commercially available from Resin Technology Division (a division of Henry Co.) of Ontario, Calif.; Foam Lok™ FL-2000™ commercially available from Lapolla Coatings of Houston, Tex.; InsulStar® commercially available from NCFI Polyurethanes (formerly North Carolina Foam Industries) of Mt. Airy, N.C.; and DuraFoam—Duraseal™ 1.9 commercially available from Urethane Contractor Supply Company of Phoenix, Ariz.

### 6—Preparation and Application of the Rigid Closed Cell Foam

The preparation of polyurethane and polyisocyanurate foam is well known in the art. It is convenient in many applications to provide the components for polyurethane or polyisocyanurate foams in pre-blended foam formulations. Most typically, the foam formulation is pre-blended into two components. The isocyanate or polyisocyanate composition comprises the first component, commonly referred to as the “A” component. The polyol or polyol mixture, surfactant, catalyst(s), blowing agent(s), flame retardant, and other isocyanate reactive components comprise the second component, commonly referred to as the “B” component. While the surfactant, catalyst(s) and blowing agent are usually placed in the “B” component, they also may be added to the “A” side, or added to both the “A” and “B” sides.

When spray foam is applied, the A-side chemicals (e.g. polyisocyanate) and B-side chemicals are mixed in appropriate amounts, typically equal amounts by volume, and then atomized into a mist. This mixing is done in a spray gun. The polyurethane or polyisocyanurate foam is created as the two chemicals mix and are deposited on the building surface. Optionally, fire retardant, colorants, auxiliary blowing agents, water, and even other polyols can be added as a third stream to the mix head of the spray gun.

Substrate preparation shall include removing loose dirt, dust and debris by using compressed air, vacuum equipment or brooming. Oil, grease, form release agents or other contaminants shall be removed with proper cleaning solutions. All joint openings in concrete decks that exceed ¼ inch shall be grouted or caulked prior to application of polyurethane foam. Priming is required on concrete surfaces, and it is recommended that poured concrete decks be permitted to cure for twenty-eight (28) days prior to the application of primer or sprayed polyurethane foam.

Sprayed polyurethane foam is not recommended for lightweight or insulating concrete unless tests have been made to determine that adequate adhesion can be obtained or unless an overlayment is installed. Prior to application of the foam, the surface shall be inspected to insure that conditions have been met.

Substrate shall have sufficient slope to eliminate excessive ponding water. Ponding is defined as the excessive accumulation of water at low-lying areas on a roof that remains 48 hours after the end of rainfall under conditions conducive to drying. If the substrate does not have sufficient slope, then the ponding water must be eliminated by building in slope by the application of polyurethane foam, channeling the polyurethane foam or by the proper placement of drains, or a combination thereof.

The polyurethane foam application shall not proceed during periods of inclement weather. The applicator shall not apply the polyurethane foam below the temperature and/or humidity specified by the manufacturer for ambient air and substrate. Wind barriers may be used if wind conditions could affect the quality of installation.

The spray polyurethane foam shall be applied in accordance with the manufacture's specification and instructions.

Areas to be built-up to remove ponding water are to be filled in with spray polyurethane foam before the specified thickness of polyurethane foam is applied to the entire building surface. The spray polyurethane foam must be applied in a minimal pass thickness of ½ inch. Spray polyurethane foam thickness shall be a minimum of one inch (or more if specified). The polyurethane foam shall be applied uniformly over the entire surface with a tolerance of plus ¼″ per inch of thickness minus 0″, except where variations are required to insure proper drainage or to complete a feathered edge. The spray polyurethane foam shall be uniformly terminated a minimum of four (4) inches above the roofline at all penetrations (except drains, parapet walls, or building junctions). Foamed in place cants shall be smooth and uniform to allow positive drainage.

The polyurethane foam surface shall be allowed to cure sufficiently. The full thickness of polyurethane foam in any area shall be completed prior to the end of each day. If due to weather conditions more than 24 hours elapse between polyurethane foam and coating application, the polyurethane foam shall be inspected for UV degradation, oxidation or contamination. If any of the above conditions exist, the surface shall be prepared in conformity with the recommendations of the manufacturer issuing the warranty.

The final sprayed polyurethane foam surface shall be “smooth, orange peel, coarse orange peel, or verge of popcorn.” Polyurethane foam surfaces termed “popcorn” or “treebark” are not acceptable. These areas shall have the surfaces remedied and refoamed to an acceptable surface condition.

Any damage or defects to the polyurethane foam surface shall be repaired prior to the protective coating application.

Polyurethane foam surface shall be free of moisture, frost, dust, debris, oils, tars, grease or other materials that will impair adhesion of the protective coating.

Prior to the application of the protective coating the polyurethane foam shall be inspected for suitability of base coat application. The polyurethane foam shall be clean, dry, and sound.

The base coat shall be applied the same day as the polyurethane foam application when possible. In no case shall less than two hours elapse between application of the polyurethane foam and application of the base coat. If more than 24 hours elapse prior to the application of base coat, the polyurethane foam shall be inspected for UV degradation.

The polyurethane foam shall be free of dust, dirt, contaminants and moisture before application of the base coat. The base coat shall be applied at a uniform thickness with the rate of application being governed by the polyurethane foam surface texture. Coatings shall be applied at such a rate as to give the minimum dry film thickness specified by the protective coating manufacturer. The coating shall be allowed to cure and be inspected for pinholes, thinly coated areas, uncured areas or other defects. Any defects should be repaired prior to subsequent applications. The base coat shall be free of dirt, dust, water, or other contaminants before application of the topcoat. The coating application shall not proceed during periods of inclement weather. The applicator shall not apply the protective coating below the temperature and/or above the humidity specified by the manufacturer for ambient air and substrate. Wind barriers may be used if wind conditions could affect the quality of installation.

Subsequent coating should be applied in a timely manner to insure proper adhesion between coats. Surface texture of polyurethane foam will affect dry film thickness—additional material may be required in areas of coarse foam profile.

The cured dry film thickness of the finished multiple coat application shall be checked by taking slit samples and examining under magnification. Areas that are found to have less than the thickness specified shall require additional coating.

The present disclosure provides a method of securing a building structure against wind forces tending to lift the deck or walls thereof which comprises:

a) providing a deck or wall;

b) spraying and adhering a rigid closed cell foam onto at least a portion of the deck or wall. The foam may be applied to the top or underside of the roof deck. Typically, the foam is applied to the top of the deck or outer surface of the wall in a commercial installation and the underside of the deck or wall in a residential installation; and

(c) optionally coating said foam with a UV resistant material. Foam UV resistant material would include, but are not limited to silicone, polyurea, acrylic, urethane, asphalt coatings, membrane roof waterproofing sheets, pavers, aggregate, or poured in-place concrete protection surfacing.

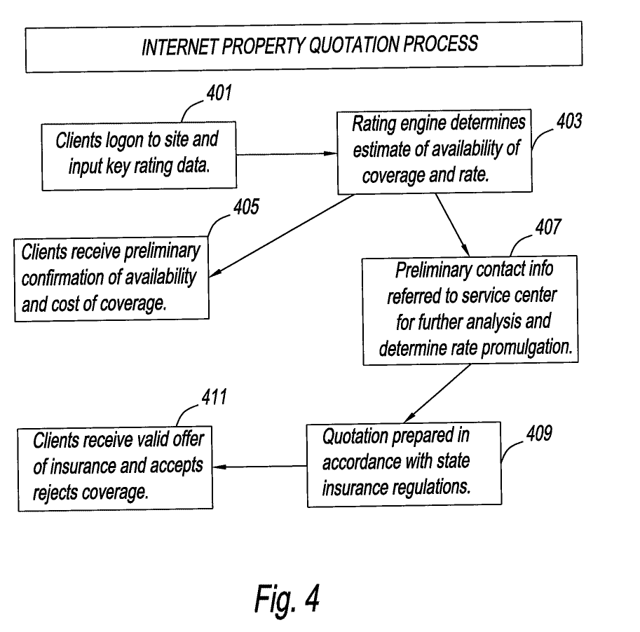

FIG. 4 demonstrates an Internet property quotation process according to an embodiment of the present disclosure, wherein clients logon to a website and input key rating data 401. Thereafter, a rating engine determines the estimate of availability of coverage and rate 403. Clients then receive preliminary confirmation of availability and cost of coverage 405 or are referred to a service center for further analysis and determination of rate promulgation 407. A quotation is then prepared in accordance with state insurance regulations 409 and client receives a valid offer of insurance and accepts or rejects coverage 411.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims. For example, it is contemplated that all presently known and available methods and systems for forming foam are readily adaptable for use in connection with the present disclosure.

What is claimed is:

1. A method for mitigating risk in issuing wind only insurance comprising:
submitting a request for said wind only insurance;
determining if a building complies with a predetermined set of parameters;
if a compliant material was used in constructing said building, authorizing said request for wind only insurance; and
issuing said wind only insurance.

2. The method according to claim 1, further comprising:
if a non-compliant material was used in constructing said building, arranging for a site visit.

3. The method according to claim 2, further comprising:
after arranging for a site visit, undertaking an analysis of any said building;
optionally, selecting a compliant material; and
installing of said compliant material.

4. The method according to claim 1, wherein said predetermined set of parameters comprises the installation of a wind uplift resistant foam.

5. The method according to claim 3, wherein said compliant material comprises a wind uplift resistant foam.

6. The method of claim 4 wherein said wind uplift resistant foam comprises a rigid closed cell foam comprises (a) a blowing agent, and (b) at least one compound selected from the group consisting of: a polyurethane and/or a polyisocyanurate polymer or combinations thereof.

7. The method of claim 6, wherein said blowing agent is at least one selected from the group consisting of: 1,1-dichloro-1-fluoroethane(HCFC-141b); 1,1,1,2-tetrafluoroethane(HFC-134a); 1,1,1,2-tetrafluoroethane(HFC-134); 1-chloro-1,1-difluoroethane(HCFC-142b); 1,1,1,3,3-pentafluorobutane(HFC-365mfc); 1,1,1,2,3,3,3-heptafluoropropane(HFC-227ea); difluoroethane(HCFC-142b); 1,1,1,3,3-pentafluoropropane(HFC-245fa), 1,1,1,2-tetrafluoroprop-1-ene(HFO-1234yf), 1,2,3,3,3-pentafluoroprop-1-ene(HFO-1225ye), 1-chloro-3,3,3-trifluoroprop-1-ene(HFO-1233zd), 1,1,1,3-tetrafluoroprop-1-ene(HFO-1234ze), 1,1,1,4,4,4-hexafluorobut-2-ene(HFO-1336mzzm(e) and HFO-1336mzzm(z)), water, formic acid, carbon dioxide, esters, chlorocarbons, ethers, fluoroethers and combinations of any of the foregoing.

8. The method of claim 7, wherein said blowing agent is selected from the group consisting of: 1,1,1,3,3-pentafluoropropane and 1,1,1,3,3-pentafluorobutane and mixtures thereof.

9. The method of claim 7, wherein said blowing agent is 1,1,1,3,3-pentafluoropropane.

10. The method of claim 6, wherein said foam comprises a compound selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

11. The method according to claim 1, wherein said request is submitted via an Internet application or paper application.

12. The method according to claim 1, further comprising:
prior to issuing said wind only insurance, undertaking a review to determine if all insurance standards are met.

13. A method for issuing wind only insurance comprising:
installing a building system;
confirming that said building system complies with a predetermined set of parameters; and
issuing said wind only insurance.

14. An integrated wind risk mitigation system comprising:
building insulation protection surfacing; and
wind only insurance.

15. The system of claim 14, wherein said building insulation protection surfacing comprises: a wind risk mitigation product, and a building system.

16. The system of claim 15 wherein said wind risk mitigation product comprises a rigid closed cell foam comprises (a) a blowing agent, and (b) at least one compound selected from the group consisting of: a polyurethane, a polyisocyanurate, a phenol, a thermoplastic polymer and combinations thereof.

17. The system of claim 16 wherein said blowing agent is at least one selected from the group consisting of: 1,1-dichloro-1-fluoroethane(HCFC-141b); 1,1,1,2-tetrafluoroethane(HFC-134a); 1,1,1,2-tetrafluoroethane(HFC-134); 1-chloro-1,1-difluoroethane(HCFC-142b); 1,1,1,3,3-pentafluorobutane(HFC-365mfc); 1,1,1,2,3,3,3-heptafluoropropane(HFC-227ea); difluoroethane(HCFC-142b); 1,1,1,3,3-pentafluoropropane(HFC-245fa), 1,1,1,2-tetrafluoroprop-1-ene(HFO-1234yf), 1,2,3,3,3-pentafluoroprop-1-ene(HFO-1225ye), 1-chloro-3,3,3-trifluoroprop-1-ene(HFO-1233zd), 1,1,1,3-tetrafluoroprop-1-ene(HFO-1234ze), 1,1,1,4,4,4-hexafluorobut-2-ene(HFO-1336mzzm(e) and HFO-1336mzzm(z)), water, formic acid, carbon dioxide, esters, chlorocarbons, ethers, fluoroethers and combinations of any of the foregoing.

18. The system of claim 17, wherein said blowing agent is selected from the group consisting of: 1,1,1,3,3-pentafluoropropane and 1,1,1,3,3-pentafluorobutane and mixtures thereof.

19. The system of claim 17, wherein said blowing agent is 1,1,1,3,3-pentafluoropropane.

20. The system of claim 16, wherein said foam comprises a compound selected from the group consisting of: a co-blowing agent, a surfactant, a polymer modifier, a toughening agent, a colorant, a dye, a solubility enhancer, a rheology modifier, a plasticizing agent, a flammability suppressant, an antibacterial agent, a viscosity reduction modifier, a filler, a vapor pressure modifier, a nucleating agent, a catalyst and a combination thereof.

21. Wind risk mitigation insurance product comprising:
a warranty against displacement of a building system from a wind uplift resistant material due to wind.

22. A computer readable storage media containing executable computer program instructions which when executed cause a processing system to perform a method for mitigating risk in issuing wind only insurance comprising:
receiving a request for said wind only insurance;
determining if a building complies with a predetermined set of parameters;
if a compliant material was used in constructing said building, authorizing said request for wind only insurance; and
issuing said wind only insurance.

23. The storage media according to claim 22, further comprising:
if a non-compliant material was used in constructing said building, arranging for a site visit.

24. The storage media according to claim 23, further comprising: after arranging for a site visit, undertaking an analysis of any said building; optionally, selecting a compliant material; and installing of said compliant material.

25. The storage media according to claim 22, wherein said predetermined set of parameters comprises the installation of a wind uplift resistant foam.

26. The storage media according to claim 24, wherein said compliant material comprises a wind uplift resistant foam.
